(19) United States
(12) Patent Application Publication
(10) Pub. No.: US 2026/0134487 A1
(43) Pub. Date: May 14, 2026

(54) SYSTEMS AND METHODS FOR DIGITAL PAYMENT NETWORK PAYROLL DISTRIBUTION

(71) Applicant: Wells Fargo Bank, N.A., San Francisco, CA (US)

(72) Inventor: Cecil B. Burrowes, Charlotte, NC (US)

(21) Appl. No.: 18/948,318

(22) Filed: Nov. 14, 2024

(51) Int. Cl. G06Q 40/12; G06Q 20/10; G06Q 20/40

(52) U.S. Cl. CPC G06Q 40/125; G06Q 20/10; G06Q 20/4014

(57) ABSTRACT

Systems, apparatuses, methods, and computer program products are disclosed for the digital payment network payroll distribution. An example method includes receiving a digital payroll request associated with a digital payment network. The example methods also include identifying one or more target recipient accounts based on the digital payroll request. The example method also includes causing a transfer of funds to at least one target recipient account of the one or more target recipient accounts.

### BACKGROUND

Current processes by which employees enroll and engage in direct deposit with employers is cumbersome. These processes are prone to errors, which may be undetectable until errors occur (e.g., a missed payment). Given the several day delay between sending and receiving payments, the traditional means of direct deposit is inadequate, especially for small businesses with limited resources and rapidly changing needs.

### BRIEF SUMMARY

Conventional processes of setting up and participating in direct deposit requires employees to share sensitive information, such as bank account numbers, with their employers. This often involves the transmission of the sensitive information to a third-party platform, a process which not only increases exposure of the sensitive data (e.g., via a data breach), but also introduces the possibility of errors which may go unnoticed until a payment has already been routed to an incorrect destination.

To manage payroll operations, small businesses must often rely on costly third-party software services that require significant training to utilize. Managing payroll through these services is also time consuming and requires employees to wait several days in most cases to receive payments from the time the funds are disbursed. In instances where employees wish to change accounts and/or institutions which receive direct deposit funds on their behalf, the process of enrolling an employee in direct deposit must be reinitiated from the beginning.

In situations where payment errors arise, the means of remediating the errors are often difficult to process for both the employee and the employer. In the case of overpayment, the employee may need to take extra time from their day to provide, for example, a check or money order for the overpaid amount. As a result, the process of returning overpayments to an employer can be very time consuming, as the funds will take several days to reach the employee after initial disbursement, then the funds will take several days to be returned once the employee has garnered a means of repayment. In the case of an underpayment, the employer needs to make an additional disbursement to pay the employee the correct amount, resulting in a delay in the employee's receipt of their full payment amount.

In contrast to the conventional techniques for administering direct deposit payroll systems as a means of disbursing compensation to employees, example embodiments described herein build upon digital payment networks to provide an improved payroll framework that leverages instantaneous payroll transfers between employers and employees via a digital payment network. A digital payment network may provide a service that enables individuals to electronically transfer money from their bank account to another registered user's bank account using a mobile device or a website of a participating banking institution. One example of a digital payment network is Zelle®. Digital payment networks provide advantages over existing peer-to-peer (P2P) payment systems (e.g., Cash App, PayPal, etc.) in that digital payment networks allow for instantaneous transfers of money between two bank accounts and instantaneous access to those funds, whereas transfers in P2P payment systems typically involve a settlement period, during which funds are unavailable to a payee for some time (e.g., between one and three days).

By leveraging a digital payment network, employees are better prepared to pay for expenses and react to unforeseen personal financial circumstances without having to endure a waiting period of up to several days before receiving their pay. Some of the example embodiments described herein provide a technical solution to circumvent problems which are caused or exacerbated by the delay that occurs when transferring funds from an employer to an employee and, in some examples, from an employee to an employer. Some of the example embodiments described herein also allow for the faster remediation of incorrect payments, the rapid disbursement of bonuses, and the quick reimbursement of employees via a single convenient system that automatically calculates and withholds taxable portions of funds disbursed to employees.

Accordingly, the present disclosure sets forth systems, methods, and apparatuses that integrate direct deposit functionality into a digital payment network. There are many advantages of these and other embodiments described herein. For instance, in traditional systems, when a new employee is hired, enrolling in their employer's payroll administration program can take one or more pay cycles before the new employee is paid appropriately. Example embodiments described herein make employee enrollment in and receipt of pay from an employer's payroll administration program instantaneous, as the digital payment network (e.g., Zelle®)allows money to move between accounts instantaneously. Furthermore, in traditional systems, when employees wish to change banks, they need to reenroll in their employer's payroll administration program. As the only information provided to an employer using Zelle® for payroll administration is an account identifier (e.g., a phone number or email address), the employee may change banks or accounts without informing their employer or needing to update their payroll information on any employer-related systems. In addition, the rapid and readily accessible nature of the fund transfers on Zelle® allows employers and employees the ability to quickly remediate overpaid and/or underpaid amounts. This solves issues plaguing existing direct deposit systems in which employees may be required to wait several days for a payment to process, spend a significant amount of time to garner a means of repayment (e.g., check or money order), and provide the repayment to the employer (who will also need to wait several days for the repayment to process). This same advantage allows for employees to receive special pay types (e.g., bonuses, reimbursements) without any significant delay. Using a digital payment network specifically configured to manage payroll processes circumvents these waiting periods. Finally, by automatically tracking transfers with automatic withholding, record keeping is greatly simplified for employers and employees. Because digital payment networks such as Zelle® are available in many banking apps and other forms, the employer and employee will both have easy access to records of paystubs, tax withholdings, and other necessary details regarding their payment history through systems they already use and have built trust in.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2A illustrates a schematic block diagram of example circuitry embodying a system device that may perform various operations in accordance with some example embodiments described herein.

FIG. 2B illustrates a schematic block diagram of example circuitry embodying a client device that may perform various operations in accordance with some example embodiments described herein.

FIG. 3 illustrates an example flowchart for digital payment network payroll onboarding, in accordance with some example embodiments described herein.

FIG. 4 illustrates an example flowchart for digital payment network payroll administration, in accordance with some example embodiments described herein.

FIG. 5 illustrates an example flowchart for automatically determining a tax withholdings amount, in accordance with some example embodiments described herein.

FIG. 6 illustrates an example flowchart for automatically generating earnings statements, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “digital payment network user identifier” refers to a unique identifier that identifies a user of a digital payment network and that is linked to one or more accounts associated with that user. In some examples, a digital payment network user identifier may be a phone number of the user. In some examples, a digital payment network user identifier may be an email address of the user. It is to be appreciated that a digital payment network user identifier may be other unique identifying data for a user, such as a unique username or the like. When a user signs up for a digital payment network (such as Zelle®), they are required to link their account(s) to the digital payment network user identifier, so that the digital payment network user identifier can be used to route payments and verify transactions. By establishing this link, the digital payment network (and associated systems) can accurately associate users with their banking accounts and allow users to send and receive funds without needing to share sensitive financial data (e.g., account numbers, routing numbers, card numbers, etc.) with other parties.

### System Architecture

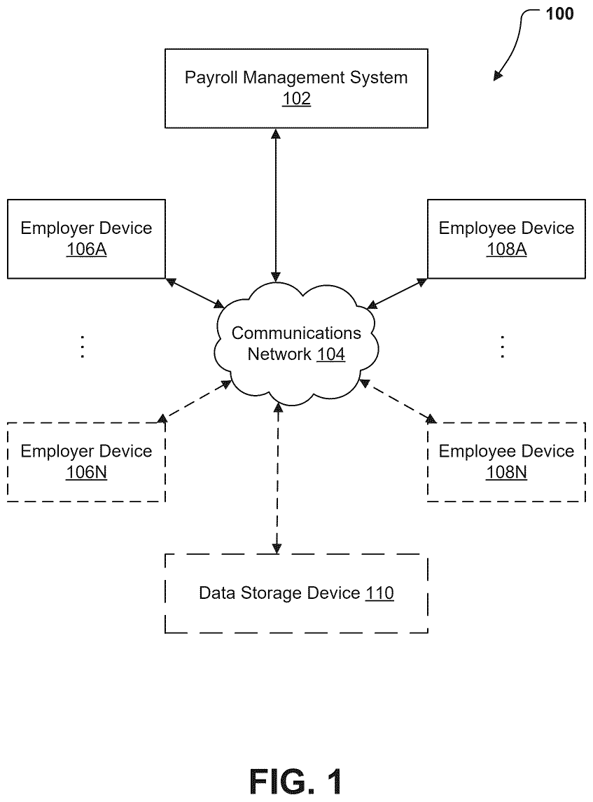

Example embodiments described herein may be implemented using any of a variety of computing devices or servers. To this end, FIG. 1 illustrates an example environment 100 within which various embodiments may operate. As illustrated, a payroll management system 102 may receive and/or transmit information via communications network 104 (e.g., the Internet) with any number of other devices, such as one or more of employer devices 106A-106N and/or employee devices 108A-108N.

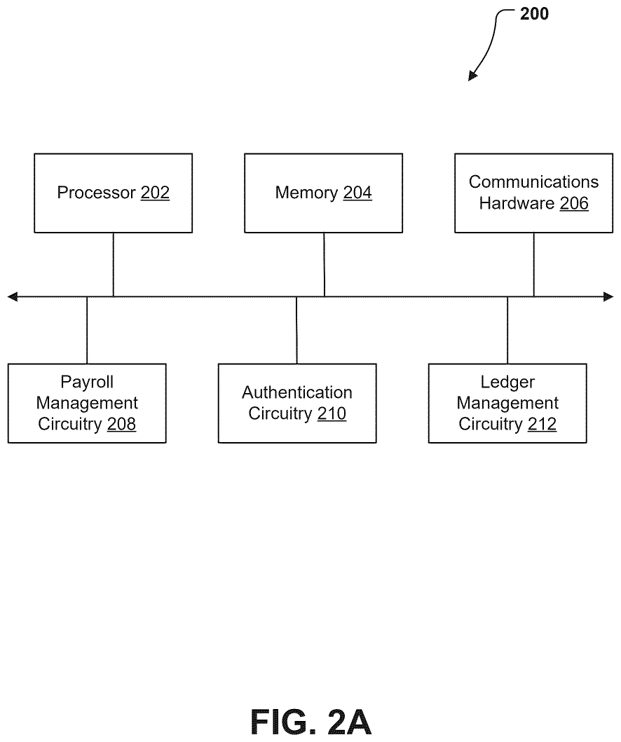

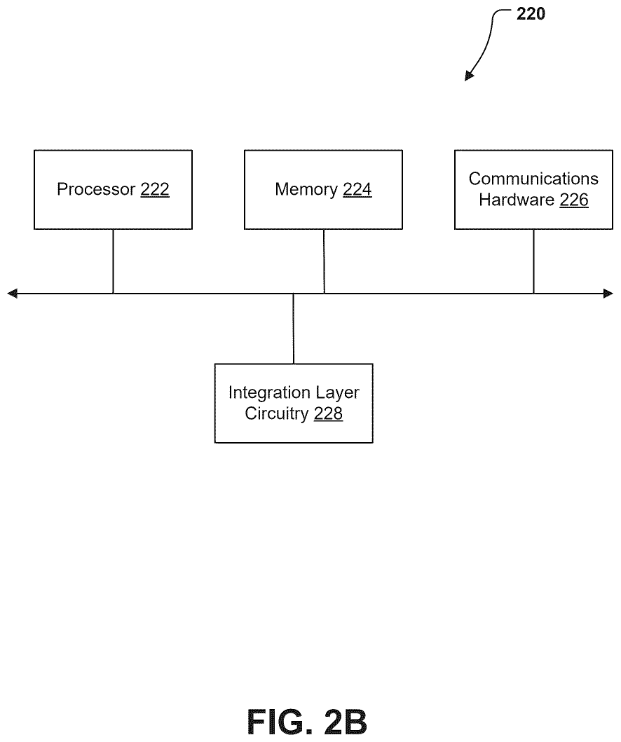

The payroll management system 102 may be implemented as one or more computing devices or servers, which may be composed of a series of components. Particular components of the payroll management system 102 are described in greater detail below with reference to apparatus 200 in connection with FIG. 2A.

In some embodiments, the payroll management system 102 further includes a storage device 110 that comprises a distinct component from other components of the payroll management system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the payroll management system 102. Storage device 110 may store information relied upon during operation of the payroll management system 102, such as various associations between digital payment network user identifiers that may be used by the payroll management system 102, data and documents to be analyzed using the payroll management system 102, or the like. In addition, storage device 110 may store control signals, device characteristics, and access credentials enabling interaction between the payroll management system 102 and one or more of the employer devices 106A-106N or employee devices 108A-108N.

In various embodiments, payroll management system 102 may be integrated as a component of a digital payment network (e.g., Zelle®) and serve as an additional layer that provides payroll-specific functionalities. In this manner, the digital payroll network may facilitate transfers of funds between individuals and/or businesses, the payroll management system 102 may add tailored payroll features such as automatic tax withholding determinations, routing, wage calculation, and the like as further described herein.

The one or more employer devices 106A-106N and the one or more employee devices 108A-108N may be embodied by any computing devices known in the art. The one or more employer devices 106A-106N and the one or more employee devices 108A-108N need not themselves be independent devices but may be peripheral devices communicatively coupled to other computing devices. In various embodiments, the one or more employer devices 106A-106N and the one or more employee devices 108A-108N may include a software application (e.g., a mobile banking application) which is associated with and facilitates interaction with the digital payment network.

Although FIG. 1 illustrates an environment and implementation in which the payroll management system 102 interacts indirectly with a user via one or more of employer devices 106A-106N and the one or more employee devices 108A-108N, in some embodiments users may directly interact with the payroll management system 102 (e.g., via communications hardware of the payroll management system 102), in which case a separate employer devices 106A-106N and the one or more employee devices 108A-108N may not be utilized. Whether by way of direct interaction or indirect interaction via another device, a user may communicate with, operate, control, modify, or otherwise interact with the payroll management system 102 to perform the various functions and achieve the various benefits described herein.

### Example Implementing Apparatuses

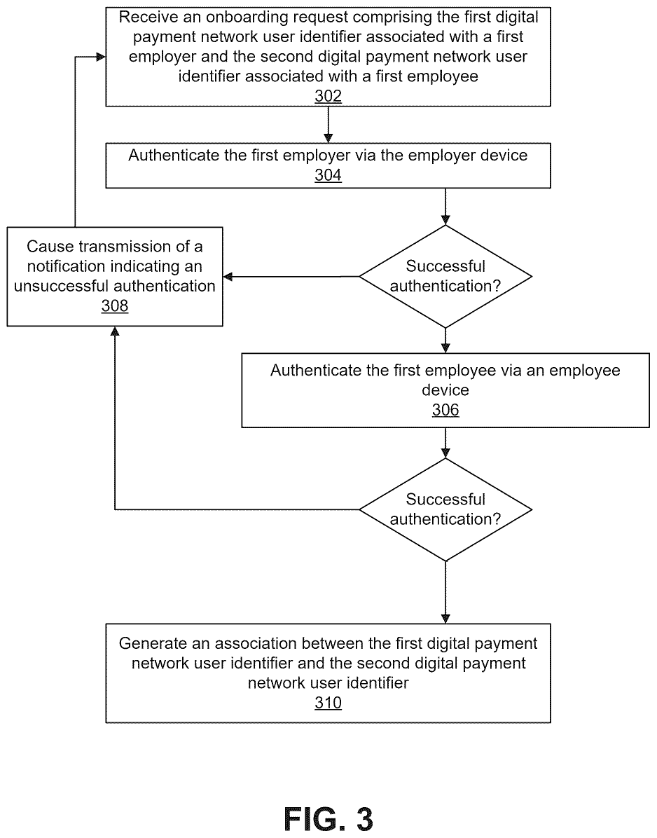

The payroll management system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-6. As illustrated in FIG. 2A, the apparatus 200 may include processor 202, memory 204, communications hardware 206, payroll management circuitry 208, authentication circuitry 210, and ledger management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises payroll management circuitry 208 that identifies target recipient accounts and determining tax withholdings amounts for transactions. The payroll management circuitry 208 may utilize processor 202, memory 204, authentication circuitry 210, ledger management circuitry 212, or any other hardware component included in the apparatus 200 to perform these operations, as described in connection with FIGS. 3-6 below. The payroll management circuitry 208 may further utilize communications hardware 206 to gather data from a variety of sources (e.g., employer device 106A through employer device 106N or storage device 110, as shown in FIG. 1), and/or exchange data with a user.

In addition, the apparatus 200 further comprises authentication circuitry 210 that authenticates an association between the first digital payment network user identifier and the second digital payment network user identifier and causes the association to be stored. The authentication circuitry may also authenticate a first employer via an employer device and/or a first employee via an employee device. The authentication circuitry 210 may utilize processor 202, memory 204, or any other hardware component included in the apparatus 200 to perform these operations, as described in connection with FIGS. 3-6 below. The authentication circuitry 210 may further utilize communications hardware 206 to gather data from a variety of sources (e.g., employer devices 106A-106N or employee devices 108A-108N, as shown in FIG. 1), and/or exchange data with a user, and in some embodiments may utilize processor 202 and/or memory 204 to validate an association between digital payment network user identifiers and stored credentials or other digital payment network user identifiers.

Further, the apparatus 200 further comprises ledger management circuitry 212 that records completed payment data in digital ledgers. The ledger management circuitry may also generate earnings statements based on digital payroll requests. The ledger management circuitry 212 may utilize processor 202, memory 204, or any other hardware component included in the apparatus 200 to perform these operations, as described in connection with FIGS. 3-6 below. The ledger management circuitry 212 may further utilize communications hardware 206 to gather data from a variety of sources (e.g., employer devices 106A-106N or employee devices 108A-108N, as shown in FIG. 1), and/or exchange data with a user.

Although components 202-212 are described in part using functional language, it will be understood that the particular implementations necessarily include the use of particular hardware. It should also be understood that certain of these components 202-212 may include similar or common hardware. For example, the payroll management circuitry 208, authentication circuitry 210, and ledger management circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition to hardware, refer to software instructions that configure the hardware components of the apparatus 200 to perform the various functions described herein.

Although the payroll management circuitry 208, authentication circuitry 210, and ledger management circuitry 212 may leverage processor 202, memory 204, or communications hardware 206 as described above, it will be understood that any of payroll management circuitry 208, authentication circuitry 210, and ledger management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that payroll management circuitry 208, authentication circuitry 210, and ledger management circuitry 212 comprise particular machinery designed for performing the functions described herein in connection with such elements of apparatus 200.

As illustrated in FIG. 2B, an apparatus 220 is shown that represents an example client device (e.g., any of employer devices 106A-106N or employee devices 108A-108N). The apparatus 220 includes processor 222, memory 224, and communications hardware 226, each of which is configured to be similar to the similarly named components described above in connection with FIG. 2A. However, the apparatus 220 also includes integration layer circuitry 228, which may be integrated into a predefined application (e.g., a mobile banking application) installed on the client device and which can retrieve data from one or more applications stored (e.g., in memory 224) on a client device and generate requests comprising the retrieved data (e.g., digital payment network user identifiers).

In some embodiments, the integration layer circuitry 228 may utilize an Application Programming Interface (API) to connect to one or more applications. For example, the integration layer circuitry 228 may utilize an API to connect to the payroll management system 102 by leveraging communications hardware 226. The integration layer circuitry 228 may also facilitate sending a credential and a digital payment network user identifier via the API. In some embodiments, the integration layer circuitry 228 may generate a digital payroll request, digital payroll remittance request, or digital reimbursement request, which can then be transmitted to the payroll management system 102.

In some embodiments, various components of the apparatuses 200 and 220 may be hosted remotely (e.g., by one or more cloud servers) and thus need not physically reside on the corresponding apparatuses 200 and 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 220. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by the payroll management system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, payroll management circuitry 208, authentication circuitry 210, ledger management circuitry 212 and/or any combination thereof. It will be understood that user interaction with the payroll management system 102 may occur directly via communications hardware 206 or may instead be facilitated by a separate communications network 104, as shown in FIG. 1, and which may have similar or equivalent physical componentry facilitating such user interaction.

Turning now to FIG. 3, example operations are shown for onboarding employees as participants in the employer's payroll administration program via the payroll management system 102 and a digital payment network. In some embodiments, an employee may be onboarded to participate in an employer's payroll program as administered via a digital payment network (e.g., Zelle®), such that the employee may begin receiving payroll-related funds (e.g., paychecks, bonuses, reimbursements, etc.) from the employer via the digital payment network.

Traditionally, enrolling in an employer's payroll program would involve the employee providing sensitive financial information (e.g., account numbers and routing numbers of one or more personal financial accounts) to the employer. The employer then in turn typically provides this information to a third-party system that manages payroll. This exposure of sensitive information to multiple parties creates numerous issues, including significantly increasing the potential for the employee's personal financial data to be compromised.

Example embodiments described herein circumvent these issues. For instance, through utilizing payroll management system 102 and a digital payment network to administer payroll, onboarding employees do not need to provide any sensitive financial data to their employers; rather, an employee only needs to provide their digital payment network user identifier to the employer in order to begin receiving payroll-related funds. For example, in the context of Zelle®, the employee may provide their phone number or email address associated with their Zelle® user account. As their digital payment network user identifier (e.g., phone number and/or email address) is already linked to one or more of their personal financial accounts, the employer can quickly begin paying the employee by using the provided digital payment network user identifier without ever needing to see an account and/or routing number.

In some embodiments, an onboarding request may be generated via payroll management system 102 comprising various data regarding a working relationship between an employer and employee. This data may include, for example, digital payment network user identifiers (e.g., a digital payment network identifier of the employer and a digital payment network identifier of the employee), and data regarding pay rate, job description, hire date, pay schedule, and/or the like). In some embodiments, an employer may create an onboarding request via their personal client device (e.g., an employer device 106A). For example, an onboarding request may be generated via a user interface (UI) within a mobile application associated with the digital payment network, such as a standalone app for the digital payment network, or a mobile banking application associated with a bank that supports the digital payment network. In this regard, the employer may provide user input (e.g., enter various data) to the UI to generate an onboarding request.

In some embodiments, as further discussed below, the onboarding request may be authenticated by authenticating the employee and confirming their willingness to participate in the employer's digital payment network-based payroll administration program. In some embodiments, authentication of the onboarding request may cause the payroll management system 102 to store (e.g., in memory 204) an association between the digital payment network user identifier of the employee and the digital payment network user identifier of the employer, thus creating a link between the two and establishing a digital trace of their working relationship. By ensuring, through this authentication process, that the employer has received correct information (e.g., a correct digital payment network user identifier) from the employee, a technical solution is provided to the technical problem of late-stage payroll error detection (e.g., an employee's inability to detect errors in their enrollment until a problem (e.g., a missed or incorrectly routed payment) has occurred).

Further, as mentioned above, since the employee need only provide their digital payment network user identifier (e.g., a phone number or an email address) in this onboarding process, the employee is able to switch banks and accounts freely without their payment from their employer being interrupted. Said differently, the employee can simply change which account their digital payment network identifier is linked to without needing to alert the employer of any change. In contrast, traditional processes require employees who wish to switch their payroll from one account to another account to restart the onboarding process from the beginning (and again provide sensitive financial information relating to a new financial account to the employer) in order to receive payroll-related funds at the new account or financial institution. In doing so, the employee may not be provided with a paycheck for one or more pay periods due to the delays inherent in the traditional means of payroll administration. Thus, example embodiments described herein provide a technical solution to the foregoing technical problem.

As shown by operation 302, the apparatus 200 includes means, such as processor 202, memory 204, communications hardware 206, or the like, for receiving an onboarding request comprising a first digital payment network user identifier and a second digital payment network user identifier. For example, in some embodiments, the first digital payment network identifier may be associated with an employer, while the second digital payment network identifier may be associated with an employee. In some embodiments, as noted above, a digital payment network user identifier may be an email address, a phone number, or another unique means of identifying a user of a digital payment network (e.g., a unique username or the like).

As shown by operation 304, the apparatus 200 includes means, such as processor 202, memory 204, communications hardware 206, authentication circuitry 210, or the like, for authenticating, based on the first digital payment network user identifier, the first employer via an employer device. In some embodiments, the employer may be authenticated by requesting and receiving an input metric from the employer (e.g., via an employer device 106A) and then comparing the input metric against stored authentication metrics associated with the employer's digital payment network user identifier. In some embodiments, the employer may provide the input metric via their device by entering a password, scanning a biometric (e.g., fingerprint scan, facial scan, retina scan, etc.), using a hyperlink, selecting one of several selectable indicia, scanning a barcode, scanning a QR code or other image, and/or the like. Once received, the payroll management system 102 may compare the input metric to a stored authentication metric associated with the employer's digital payment network user identifier. For example, the payroll management system 102 may confirm an input password matches a stored password for the employer. As another example, the payroll management system 102 may confirm that a fingerprint scan satisfies a predefined similarity threshold to a previously-submitted fingerprint scan of the employer.

As shown by operation 306, the apparatus 200 includes means, such as processor 202, memory 204, communications hardware 206, authentication circuitry 210, or the like, for authenticating, based on the second digital payment network user identifier, the first employee via an employee device. As shown in FIG. 3, in some embodiments, this may be performed in response to a successful authentication of the first employer. In some embodiments, the employee may be authenticated by requesting and receiving an input metric from the employee (e.g., via an employer device 106A) and then comparing the input metric against stored authentication metrics associated with the employee's digital payment network user identifier. In some embodiments, the employee may provide the input metric via their device by entering a password, scanning a biometric (e.g., fingerprint scan, facial scan, retina scan, etc.), using a hyperlink, selecting one of several selectable indicia, scanning a barcode, scanning a QR code or other image, and/or the like. Once received, the payroll management system 102 may compare the input metric to a stored authentication metric associated with the employee's digital payment network user identifier. For example, the payroll management system 102 may confirm an input password matches a stored password for the employee. As another example, the payroll management system 102 may confirm that a fingerprint scan satisfies a predefined similarity threshold to a previously-submitted fingerprint scan of the employee. In some embodiments, an authentication request sent to an employee device in response to receiving an onboarding request (generated by the employer) may be coupled with information included in the onboarding request to provide context for the employee. For example, the authentication request can indicate the employer's name, job description, pay rate, pay schedule, and/or other data included in the onboarding request such that the employee is equipped with enough information to confirm authenticity of the request.

As shown by operation 308, the apparatus 200 includes means, such as processor 202, memory 204, communications hardware 206, or the like, for causing transmission of a notification indicating an unsuccessful authentication. In some situations, such as an incorrectly input metric (e.g., a mistyped password or an incomplete biometric scan) being entered by one or both of the employer or employee, payroll management system 102 may cause transmission of a notification to the employer device, the employee device, or both, indicating that the authentication has failed. In some embodiments, after an authentication has been determined to be unsuccessful, the process may return to operation 302.

As shown by operation 310, the apparatus 200 includes means, such as processor 202, memory 204, communications hardware 206, payroll management circuitry 208, or the like, for generating an association between the first digital payment network user identifier and the second digital payment network user identifier. In some embodiments, generating the association between the first digital payment network user identifier and the second digital payment network user identifier may comprise assigning a linking identifier to both the first digital payment network user identifier and second digital payment network user identifier. This association effectively links the employee to the employer within the payroll management system 102 and the digital payment network. In some embodiments, the association between the first digital payment network user identifier and second digital payment network user identifier may be stored in memory 204 in response to the successful authentication of the first digital payment network user identifier and second digital payment network user identifier. In some embodiments, the association between the first digital payment network user identifier and second digital payment network user identifier may be used to direct payments from the employer to the employee (and vice versa, in some circumstances) as well as enable other services via the payroll management system 102. For example, by establishing this association, the employer may easily manage and pay the employee (and other employees) through a mobile application (e.g., a mobile banking application). In this regard, the association may allow the employer to view a list of all employees within the application, enabling the employer to quickly find and select specific employees for payment, thus eliminating manual entry of employee details and reducing the risk of payment errors.

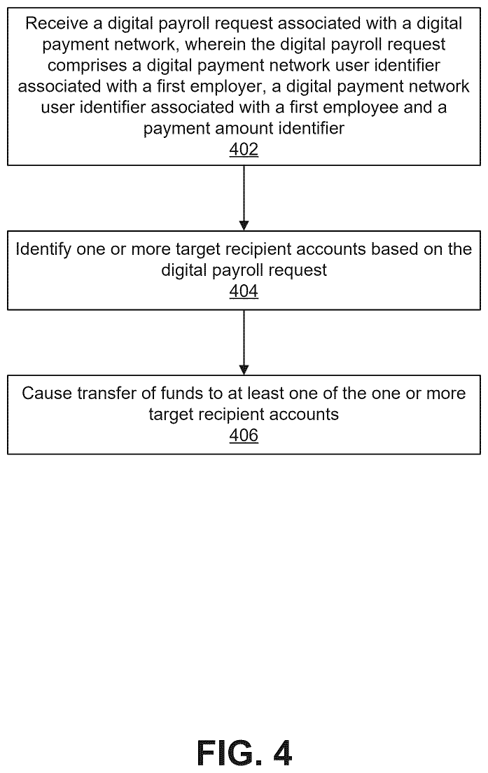

Turning first to FIG. 4, example operations are shown for payroll administration through a digital payment network and integrated payroll management system 102. In some embodiments, the operations shown in FIG. 4 may be carried out in response to an employer submitting a digital payroll request to send funds to an employee via a digital payment network (e.g., Zelle®). In other embodiments, the operations shown in FIG. 4 may be carried out in response to an employee submitting a digital payroll request via their employee device to send funds to an employer (e.g., in the case of remittance of an overpayment) via a digital payment network (e.g., Zelle®). In some embodiments, a digital payroll request is generated and the digital payroll request is transmitted to the payroll management system 102 via an employer device (e.g., employer device 106A). In this regard, as shown in operation 402, the apparatus 200 includes means, such as processor 202, memory 204, communications hardware 206, or the like, for receiving a digital payroll request associated with a digital payment network. In various embodiments, the digital payroll request may comprise a first digital payment network user identifier associated with a first employer, a second digital payment network user identifier associated with a first employee, a payroll operation indicator, and a payment amount identifier (which identifies an amount of funds to be transferred).

In some embodiments, the digital payroll request may be generated based on information input by an employer using an employer device 106A which has been configured with integration layer circuitry 228 as shown in FIG. 2B. The employer device 106A, through integration layer circuitry 228, may, in some embodiments, display specific user interface elements (e.g., via a mobile application) allowing entry of data to complete a digital payroll request (e.g., digital payment network user identifiers, a payroll operation indicator, and optionally additional data regarding the payment, such as hours worked, pay rate, dates, etc.).

A payroll operation indicator comprises data that designates a payment as a particular payment type. Payment types may include a payroll disbursement, a remittance, or a reimbursement. In various embodiments, the payroll operation indicator may be leveraged by payroll management system 102 to determine whether the funds of the payment should be taxed, as further discussed below. In some embodiments, a payroll operation indicator may be generated and included in a digital payroll request in response to a user specifying the payment type via a UI of a mobile banking application. For example, a user may select a radio button from a set of radio buttons corresponding to payroll disbursement, remittance, and reimbursement when creating a digital payroll request.

As shown by operation 404, the apparatus 200 may include means, such as processor 202, memory 204, communications hardware 206, payroll management circuitry 208, or the like, for identifying one or more target recipient accounts based on the digital payroll request. In some example embodiments, one target recipient account of the one or more target recipient accounts may be a custodian account that is designated to hold funds that may normally be withheld from a paycheck as a result of tax burdens which may apply to the payment. In some embodiments, the employee may have designated multiple of their own personal accounts as the one or more target recipient accounts.

In some embodiments, the first digital payment network identifier associated with the employer may be referenced to identify a custodian account associated with the employer for withholding taxable portions of employee payments. In some embodiments, the digital payment network identifier associated with the employee may be referenced against stored data (e.g., in memory 204, another database, and/or the like) to identify one or more target recipient accounts (e.g., accounts which are linked to the digital payment network user identifier via the digital payment network). For example, employees may wish to allocate a portion of funds to a single target recipient account, with one or more other portions allocated to other target recipient accounts. Advantageously, example embodiments allow for employees to designate account allocation instructions that may not be known by the employer. As the only information provided to the employer is the employee's digital payment network user identifier, the employee may adjust their allocation instructions (e.g., linked accounts) without interruption to their payment schedule or any further direct interaction with the employer's payroll administration program. In some embodiments, an employee may adjust allocation instructions via a UI of their mobile banking application on an employee device 108A. Furthermore, the employee may designate the amount of each payment which is allocated to the one or more target recipient accounts as either absolute dollar amounts or relative amounts (e.g., percentages) of the total payment amount based on the payment amount identifier.

In some embodiments, a digital payroll request may comprise a payroll operation indicator that indicates a remittance. A remittance may involve a previous mispayment of the employee (e.g., underpaying the employee or overpaying the employee). In such cases, the payroll management system 102 may identify, from the digital payroll request, one or more target recipient accounts, the amount of pay that must be remitted, which party (e.g., the employer or the employee) must remit the difference in pay, if the incorrect payment was less than or in excess of the correct payment amount, as well as metadata related to the transaction. Subsequently, the payroll management system 102 may cause transfer of funds to at least one of the one or more target recipient accounts. As an example, in the case of an employee who was initially underpaid, a portion of the corrected payment may be transferred to the employee and a portion may be sent to a custodian account (e.g., a tax withholdings account). As another example, if an employee were overpaid, the employee may transfer the overpaid amount to the employer, and the amount of tax withholdings which was in excess of the correct payment amount may be automatically transferred back to the employer from the custodian account it was held in by the payroll management system 102. In some embodiments, a digital payroll request comprising a payroll operation indicator indicating a remittance operation may comprise such information as the difference in disbursed pay and owed pay, submitted hours worked and actual hours worked, or other details which may be necessary for the completion of the transaction and accurate determination of incorrectly taxed amounts. Some embodiments may comprise the identification of a non-custodian account of the employer serving as one of the one or more target recipient accounts.

As shown by operation 406, the apparatus 200 includes means, such as processor 202, memory 204, communications hardware 206, payroll management circuitry 208, or the like, for causing, in accordance with the payroll operation indicator, a transfer of funds to at least one target recipient account of the one or more target recipient accounts. In some embodiments, the amount of funds transferred is based on the payment amount identifier and the one or more target recipient accounts identified in operation 404. For example, in some embodiments, the employee may have previously defined allocation instructions which indicate the employee's preferred method of funds distribution. In such cases, for example, the payroll management circuitry 208 may cause the transfer of portions of funds to various accounts in line with the amounts (or percentages) designated by the employee.

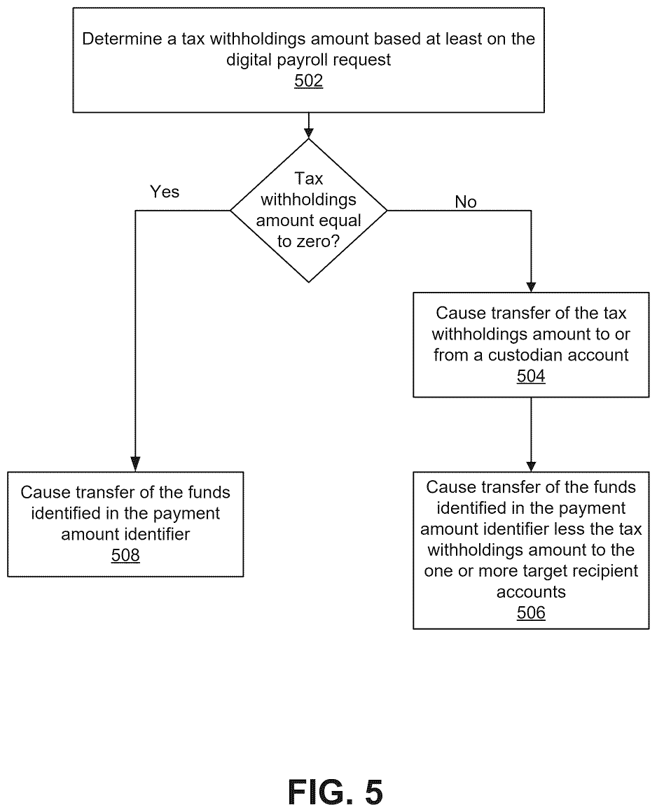

Turning to FIG. 5, example operations are shown for determining a tax withholdings amount based on a digital payroll request. In some embodiments, a payroll operation indicator included in a digital payroll request may be used to determine a tax withholdings amount. In some embodiments, it may be determined that payments made to employees are subject to certain tax burdens from state, county, federal, and/or other taxes. These taxes may comprise income tax, social security tax, and other related taxes on earned income. The tax withholdings amount may comprise an amount of funds from an employee's earned income which must be remitted to satisfy the tax burden imposed on the earned income. The tax withholdings amount may, in some example embodiments, be transferred to a custodian account for remittance as part of the process of paying an employee. In these cases, the employee may receive the difference between the total payment amount earned and the tax withholdings amount.

As shown in operation 502, the apparatus 200 includes means, such as processor 202, memory 204, communications hardware 206, payroll management circuitry 208, or the like, for determining a tax withholdings amount based at least on the digital payroll request. In some embodiments, the payroll operation indicator may indicate that a payroll disbursement is being performed and, in such cases, will apply standard tax rules according to federal, state, and local laws. In some embodiments, payroll management circuitry 208 may determine the tax withholdings amount based on metadata included in the digital payroll request (e.g., data indicating a location where the work took place (e.g., a state) and/or where the request was initiated). In some embodiments, the payroll operation indicator may indicate that a reimbursement is being performed and, in such cases, payroll management circuitry 208 may determine that no tax burden is to be enforced on the disbursement. For example, a reimbursement may involve reimbursing the employee for business-related expenses incurred by the employee. In some embodiments, the payroll operation indicator may indicate that a remittance is being performed and, in such cases, will apply standard tax-rules according to federal, state, and local laws. In some embodiments, the digital payroll request may indicate that the employee that is not subject to any tax burdens and, as such, payroll management circuitry 208 may determine that no tax burden is to be enforced on the disbursement.

As shown in operation 504 the apparatus 200 includes means, such as processor 202, memory 204, communications hardware 206, payroll management circuitry 208, or the like, for causing transfer of the tax withholdings amount to or from a custodian account in response to determining that the tax withholdings amount is not equal to zero. As discussed above, the custodian account may be account designated to hold funds corresponding to tax withholdings amounts for the employer. In some embodiments involving a remittance, e.g., when an employee is returning overpaid funds, the overpaid taxes corresponding to the overpayment amount disbursed to the employee will be returned from the custodian account automatically by the payroll management system 102 in order to fully reverse the excess disbursement.

As shown in operation 506 the apparatus 200 includes means, such as processor 202, memory 204, communications hardware 206, payroll management circuitry 208, or the like, for causing transfer of the funds identified in the payment amount identifier less the tax withholdings amount to the one or more target recipient accounts. In some embodiments, the difference between the total amount of disbursed funds and the tax withholding amount may be transferred to one or more target recipient accounts, in accordance with an employee's payroll allocation data and the payroll operation indicator.

As shown in operation 508 the apparatus 200 includes means, such as processor 202, memory 204, communications hardware 206, payroll management circuitry 208, or the like, for causing transfer of the funds identified in the payment amount identifier to the one or more target recipient accounts in response to determining that the tax withholdings amount is equal to zero. In some embodiments, the total amount of disbursed funds may be transferred to one or more target recipient accounts, in accordance with an employee's payroll allocation data and the payroll operation indicator. This may be the case in the event of a reimbursement as indicated the payroll operation indicator of the digital payroll request. In some embodiments, in the case of a reimbursement, the digital payroll request may include reimbursable expense data (e.g., a receipt, invoice, or the like) that includes information about the expense being reimbursed. In this regard, the payroll management system 102 may also confirm that the digital payroll request comprises reimbursable expense data prior to causing the transfer of funds. In some embodiments, as discussed above, an employer or employee may be authenticated by comparing an input metric against a set of stored authentication metrics associated with the employer's or the employee's digital payment network user identifier.

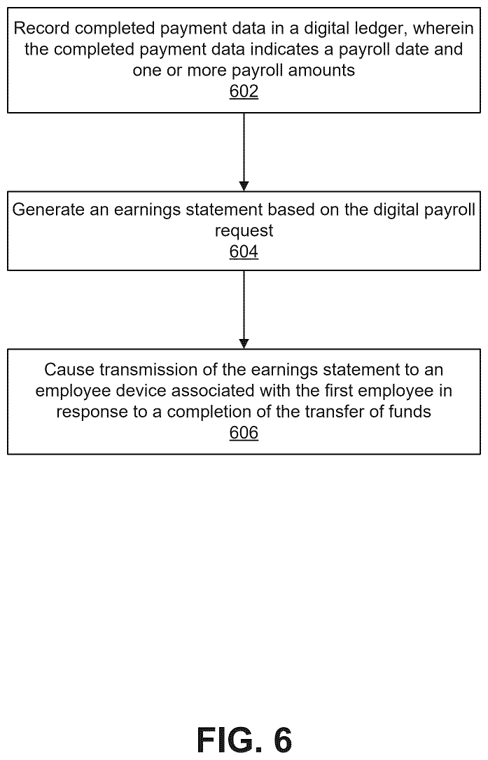

Turning to FIG. 6, example operations are shown for automatically generating earnings statements. As shown in operation 602, the apparatus 200 includes means, such as processor 202, memory 204, communications hardware 206, ledger management circuitry 212, or the like, for recording completed payment data in a digital ledger. In some embodiments, completed payment data may be compiled by the payroll management system 102 and stored in memory 204. In some embodiments, completed payment data may comprise a payroll date, one or more payroll amounts, a payroll operation indicator, and the amount of transferred funds which were sent to one or more target recipient accounts, which may include a custodian account, or accounts, associated with the employee's digital payment network user identifier. In some embodiments, completed payment data may include additional details, such as such as the number of hours worked per pay period, a work location, and/or the like. In some embodiments, the payroll management system 102 (in response to recording the completed payment data in the digital ledger) may generate an earnings statement and cause transmission of the earnings statement (e.g., via communications network 104) to an employer device 106A, an employee device 108A, or both. In some embodiments, the completed payment data stored in the ledger may be enabled to be readily accessed by the employer and/or employee, such as in the case of an employee using payment records to provide proof of income or for the preparation of tax forms by an employer or a representative thereof.

As shown in operation 604, the apparatus 200 includes means, such as processor 202, memory 204, ledger management circuitry 212, or the like, for generating an earnings statement based on the digital payroll request. In some embodiments, the earnings statement may comprise some or all of the completed payment data recorded in the digital ledger. In some embodiments, the earnings statement may be in the form of an image, a text document, a portable document file (PDF), or the like.

As shown in operation 606, the apparatus 200 includes means, such as processor 202, memory 204, communications hardware 206 or the like, for causing transmission of the earnings statement to an employee device associated with the first employee in response to a completion of the transfer of funds. In some embodiments, the earnings statement may be sent to an employer device (e.g., employer device 106A) in addition to the employee device. In some embodiments, an earnings statement may be stored in order to be readily accessed at a future date if needed.

FIGS. 3, 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved payroll administration by integrating a payroll management system within a digital payment network. By administering payroll over a digital payment network, delays in payment processing and receipt are avoided, as well as issues stemming from these delays. Example embodiments thus provide tools that overcome the problems faced by traditional payroll administration processes. As one example, remittance of overpaid amounts to employees may be accomplished near-instantaneously using the process disclosed herein, while traditionally, this could take several days and include payment processing delays. Moreover, embodiments described herein avoid waiting periods for reimbursement for work-related expenditures. By integrating a payroll management system to administer payroll operations via a digital payment network, same-day payroll processing can be realized with accurate and automatic record keeping and, additionally, digital payment network users are provided with a user-friendly and efficient tool for managing direct deposit and payroll-related operations from the comfort of their personal devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
receiving, by communications hardware, a digital payroll request associated with a digital payment network, wherein the digital payroll request comprises a first digital payment network user identifier associated with a first employer, a second digital payment network user identifier associated with a first employee, a payroll operation indicator, and a payment amount identifier;
identifying, by payroll management circuitry, one or more target recipient accounts based on the digital payroll request; and
causing, by the communications hardware and in accordance with the payroll operation indicator, a transfer of funds to at least one target recipient account of the one or more target recipient accounts.

2. The method of claim 1, wherein the payroll operation indicator indicates one of:
a payroll disbursement,
a reimbursement, or
a remittance.

3. The method of claim 1, further comprising onboarding the first employee, wherein onboarding the first employee comprises:
receiving, by the communications hardware, an onboarding request comprising the first digital payment network user identifier and the second digital payment network user identifier; and
generating, by authentication circuitry, an association between the first digital payment network user identifier and the second digital payment network user identifier.

4. The method of claim 3, wherein onboarding the first employee further comprises:
authenticating, by the authentication circuitry and based on the first digital payment network user identifier, the first employer via an employer device;
authenticating, by the authentication circuitry and based on the second digital payment network user identifier, the first employee via an employee device; and
storing, by the communications hardware, the association between the first digital payment network user identifier and the second digital payment network user identifier in response to a successful authentication of the first employer and a successful authentication of the first employee.

5. The method of claim 1, further comprising:
recording, by ledger management circuitry, completed payment data in a digital ledger, wherein the completed payment data indicates a payroll date and one or more payroll amounts;
generating, by the ledger management circuitry, an earnings statement based on the digital payroll request; and
in response to a completion of the transfer of funds, causing, by the communications hardware, transmission of the earnings statement to an employee device associated with the first employee.

6. The method of claim 1, further comprising:
determining, by the payroll management circuitry, a tax withholdings amount based at least on the digital payroll request.

7. The method of claim 6, further comprising:
causing, by the communications hardware, transfer of the tax withholdings amount to or from a custodian account; and
causing, by the communications hardware, transfer of the funds identified in the payment amount identifier less the tax withholdings amount to the one or more target recipient accounts.

8. The method of claim 1, further comprising:
storing, by the communications hardware, payroll allocation data comprising one or more target recipient accounts associated with a digital payment network user identifier associated with a first employee and one or more amounts to be directed to the one or more target recipient accounts associated with the digital payment network user identifier of the first employee.

9. The method of claim 1, wherein the payroll operation indicator indicates a reimbursement, wherein the digital payroll request further comprises reimbursable expense data, and wherein the method further comprises:
authenticating, by authentication circuitry, the reimbursable expense data prior to causing the transfer of funds.

10. An apparatus comprising:
communications hardware configured to receive, from a first device, a digital payroll request associated with a digital payment network, wherein the digital payroll request comprises a first digital payment network user identifier associated with a first employer, a second digital payment network user identifier associated with a first employee, a payroll operation indicator, and a payment amount identifier;
payroll management circuitry configured to identify, based on the digital payroll request, one or more target recipient accounts; and
communications hardware further configured to cause, in accordance with the payroll operation indicator, a transfer of funds to at least one target recipient account of the one or more target recipient accounts.

11. The apparatus of claim 10, wherein the payroll operation indicator indicates one of:
a payroll disbursement,
a reimbursement, or
a remittance.

12. The apparatus of claim 10, wherein the communications hardware is further configured to receive an onboarding request comprising the first digital payment network user identifier and the second digital payment network user identifier; and
wherein the apparatus further comprises authentication circuitry configured to generate an association between the first digital payment network user identifier and the second digital payment network user identifier.

13. The apparatus of claim 12, wherein the authentication circuitry is further configured to:
authenticate, based on the first digital payment network user identifier, the first employer via an employer device, and
authenticate, based on the second digital payment network user identifier, the first employee via an employee device; and
wherein the communications hardware is further configured to store the association between the first digital payment network user identifier and the second digital payment network user identifier in response to a successful authentication of the first employer and a successful authentication of the first employee.

14. The apparatus of claim 10, further comprising ledger management circuitry configured to:
record completed payment data in a digital ledger, the completed payment data comprising a payroll date and one or more payroll amounts, and
generate an earnings statement based on the digital payroll request,
wherein the communications hardware is further configured to cause, in response to a completion of the transfer of funds, transmission of the earnings statement to an employee device associated with the first employee.

15. The apparatus of claim 10, wherein the payroll management circuitry is further configured to determine a tax withholdings amount based at least on the digital payroll request.

16. The apparatus of claim 15, wherein the communications hardware is further configured to:
cause transfer of the tax withholdings amount to a custodian account, and
cause transfer of the funds identified in the payment amount identifier less the tax withholdings amount to the one or more target recipient accounts.

17. The apparatus of claim 10, wherein the communications hardware is further configured to store payroll allocation data comprising one or more target recipient accounts associated with a digital payment network user identifier associated with a first employee and one or more amounts to be directed to the one or more target recipient accounts associated with the digital payment network user identifier of the first employee.

18. The apparatus of claim 10, wherein the payroll operation indicator indicates a reimbursement, wherein the digital payroll request further comprises reimbursable expense data, and wherein the apparatus further comprises authentication circuitry configured to:
authenticate the reimbursable expense data prior to causing the transfer of funds.

19. A computer program product comprising at least one non-transitory computer-readable storage medium storing software instructions that, when executed, cause an apparatus to:
receive a digital payroll request associated with a digital payment network, wherein the digital payroll request comprises a first digital payment network user identifier associated with a first employer, a second digital payment network user identifier associated with a first employee, a payroll operation indicator, and a payment amount identifier;
identify one or more target recipient accounts based on the digital payroll request; and
cause, in accordance with the payroll operation indicator, a transfer of funds to at least one target recipient account of the one or more target recipient accounts.

20. The computer program product of claim 19, wherein the payroll operation indicator indicates one of:
a payroll disbursement,
a reimbursement, or
a remittance.
